(19) United States
(12) Patent Application Publication
(10) Pub. No.: US 2024/0404267 A1
(43) Pub. Date: Dec. 5, 2024

(54) METHOD FOR RECOGNIZING EMOTION, TRAINING METHOD, APPARATUSES, DEVICE, STORAGE MEDIUM AND PRODUCT

(71) Applicant: SUZHOU METABRAIN INTELLIGENT TECHNOLOGY CO., LTD., Suzhou, Jiangsu (CN)

(72) Inventors: Yaqian ZHAO, Suzhou, Jiangsu (CN); Binqiang WANG, Suzhou, Jiangsu (CN); Gang DONG, Suzhou, Jiangsu (CN); Rengang LI, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/697,413

(22) PCT Filed: Sep. 29, 2022
(86) PCT No.: PCT/CN2022/122788

§ 371 Date: Mar. 29, 2024

(30) Foreign Application Priority Data
Feb. 9, 2022 (CN) 202210119803.3

(51) Int. Cl. G06V 10/82; G06V 10/776; G06V 20/40

(52) U.S. Cl. CPC G06V 10/82; G06V 10/776; G06V 20/40

(57) ABSTRACT

A method for recognizing emotion, a training method, apparatuses, a device, a storage medium and a product. The method for recognizing emotion includes: acquiring to-be-recognized spiking sequences corresponding to video information; and recognizing the to-be-recognized spiking sequences by using a spiking neural network emotion recognition model, so as to obtain a corresponding emotion category.

### CROSS-REFERENCE TO RELATED DISCLOSURE

The present application is a National Stage Application of PCT International Application No. PCT/CN2022/122733 filed Sep. 29, 2022, which claims the benefit of priority to Chinese Patent Disclosure No. 202210119803.3, filed to the China National Intellectual Property Administration on Feb. 9, 2022 and entitled “Method for recognizing emotion and Apparatus, System and Computer-Readable Storage Medium”, which is incorporated herein by reference in its entirety. To the extent appropriate, a claim of priority is made to each of the above disclosed applications.

### TECHNICAL FIELD

Embodiments of the present disclosure relate to the technical field of emotion recognition, and in particular to a method for recognizing emotion, a method for training emotion recognition model, apparatuses, an electronic device, a computer non-transitory readable storage medium, and a computer program product.

### BACKGROUND

In the related art, with the continuous development of cloud computing, big data and artificial intelligence, applications including but not limited to face recognition and gait recognition have been widely applied to various industries. An artificial intelligence customer service dialog is another important commercial scenario. This potential application of human-machine interaction poses many challenges to the current situations, in which one important challenge is how to enable a machine to understand the emotion of a human during human-machine interaction, i.e. an emotion recognition task. Emotion recognition, as a hot research topic in the field of emotional computing, has attracted attention from many researchers in fields such as computer vision, natural language processing and human-machine interaction. Most methods use an Artificial Neural Network (ANN, or ANNs, i.e. Artificial Neural Networks) to complete the emotion recognition. However, the reasoning of an emotion recognition model needs to consume large energy of a mobile terminal device, and this high-energy-consumption emotion recognition manner of ANNs mode hinders the application of emotion recognition in embedded and mobile devices.

As a third-generation neural network, a low-power-consumption Spiking Neural Network (SNN, or SNNs, i.e. Spiking Neural Networks) is a potential solution for achieving an emotion recognition algorithm applicable to embedded and mobile terminals; and compared with ANN, the construction of a single neuron in SNN has a stronger similarity with the structure of a neuron in the brain.

In the related art, a method for completing an emotion recognition task by using SNNs is generally applied to extract emotion information from voice, cross-modality or electroencephalogram, and extracting emotion information from a video clip has not been realized, thereby limiting ways for emotion recognition. Therefore, how to extract emotion information from a video clip is a problem requiring to be solved by a person skilled in the art.

### SUMMARY

An object of embodiments of the present disclosure is to provide a method for recognizing emotion, a method for training emotion recognition model, an apparatuses, an electronic device, a computer non-transitory readable storage medium, and a computer program product, which may recognize an emotion category on the basis of video information in a use process, so that the ways for emotion recognition increase, which is beneficial to better achieve emotion recognition.

In order to solve the technical problem, embodiments of the present disclosure provide a method for recognizing emotion, including:
to-be-recognized spiking sequences corresponding to video information are acquired; and
the to-be-recognized spiking sequences are recognized by using a spiking neural network emotion recognition model, so as to obtain a corresponding emotion category.

In some embodiments of the present disclosure, before the to-be-recognized spiking sequences corresponding to video information are acquired, the method further includes:
a pre-established spiking neural network emotion recognition model is trained, to obtain a trained spiking neural network emotion recognition model.

In some embodiments of the present disclosure, the pre-established spiking neural network emotion recognition model is trained, to obtain the trained spiking neural network emotion recognition model, includes:
test sets of a plurality of emotion categories are acquired; and
test training is performed on the pre-established spiking neural network emotion recognition model by using the test sets, to obtain a trained spiking neural network emotion recognition model.

In some embodiments of the present disclosure, the pre-established spiking neural network emotion recognition model is trained, to obtain the trained spiking neural network emotion recognition model, includes:
an emotion recognition-based dynamic visual data set is pre-established; and
the pre-established spiking neural network emotion recognition model is trained by using the dynamic visual data set, to obtain a trained spiking neural network emotion recognition model.

In some embodiments of the present disclosure, the process that the emotion recognition-based dynamic visual data set is pre-established includes:
emotion recognition-based raw visual data is acquired;
simulation processing is performed on the raw visual data by using a dynamic visual sensor simulation method to obtain a plurality of spiking sequences corresponding to the raw visual data; or spiking sequences corresponding to the raw visual data are directly acquired by using a dynamic visual camera; and
an emotion recognition-based dynamic visual data set is established on the basis of the plurality of spiking sequences.

In some embodiments of the present disclosure, the process that simulation processing is performed on the raw visual data by using the dynamic visual sensor simulation method to obtain a plurality of spiking sequences corresponding to the raw visual data, includes:
N frames of video frame images in raw dynamic video data are sequentially traversed, where N represents the total number of video frame images contained in the raw visual data;
when traversing to a current ith frame, a video frame image of the current ith frame is converted from an RGB color space to a grayscale space, and the converted video frame data is taken as current video frame data, where the numerical range of i is from 1 to N; and
when the value of i is equal to 1, all floating-point data of the current video frame data is assigned to a first output channel of a first time step of simulation data, to obtain a spiking sequence composed of the first output channel.

In some embodiments of the present disclosure, the process that simulation processing is performed on the raw visual data by using the dynamic visual sensor simulation method to obtain corresponding spiking sequences, further includes:
when i is not equal to 1, the first output channel and a second output channel are respectively assigned according to a grayscale difference value between the current video frame and the previous video frame and a preset threshold, and the current video frame data is taken as the previous video frame;
the value of i is updated by adding 1; and
when the updated i is less than N, the step that the video frame image of the current ith frame is converted from the RGB color space to the grayscale space, and the converted video frame data is taken as the current video frame data is executed.

In some embodiments of the present disclosure, the process that simulation processing is performed on the raw visual data by using the dynamic visual sensor simulation method to obtain corresponding spiking sequences, further includes:
when the updated i is not less than N, traversing of the N frames of video frame images in the raw dynamic video data is completed, to obtain spiking sequences composed of the first output channel and the second output channel.

In some embodiments of the present disclosure, the first output channel and the second output channel are respectively assigned according to the grayscale difference value between the current video frame and the previous video frame and the preset threshold, includes:
for each pixel, a grayscale difference value between the current video frame and the previous video frame at the pixel is calculated;
when the grayscale difference value is greater than the preset threshold, 1 is assigned to a position corresponding to the first output channel; or
when the grayscale difference value is less than the preset threshold, 1 is assigned to a position corresponding to the second output channel.

In some embodiments of the present disclosure, the spiking neural network includes a voting neuronal population;
the pre-established spiking neural network emotion recognition model is trained by using the dynamic visual data set, to obtain the trained spiking neural network emotion recognition model, includes:
a parameter weight of the pre-established spiking neural network emotion recognition model is initialized;
the dynamic visual data set is used as an input to a current spiking neural network in the spiking neural network emotion recognition model, and an output frequency of the voting neuronal population of each emotion category is obtained via forward propagation of the current spiking neural network;
regarding each emotion category, an error between the output frequency of the voting neuronal population of the emotion category and a real label of a corresponding emotion category is calculated
a gradient corresponding to the parameter weight is calculated according to the error, and the parameter weight of the current spiking neural network is updated by using the gradient;
it is judged whether the current spiking neural network after updating the parameter weight converges; and
when it is judged that the current spiking neural network after updating the parameter weight has converged, the training ends, to obtain a trained spiking neural network emotion recognition model.

In some embodiments of the present disclosure, the pre-established spiking neural network emotion recognition model is trained by using the dynamic visual data set, to obtain the trained spiking neural network emotion recognition model, further includes:
when it is judged that the current spiking neural network after updating the parameter weight has not converged, the method returns to execute the step that the dynamic visual data set is used as the input to the current spiking neural network in the spiking neural network emotion recognition model, and the output frequency of the voting neuronal population of each emotion category is obtained via forward propagation of the current spiking neural network.

In some embodiments of the present disclosure, it is judged whether the current spiking neural network after updating the parameter weight converges according to the following manners:
by judging whether current training number of times of the current spiking neural network after updating the parameter weight reaches a preset number of times, it is judged whether the current spiking neural network converges; or
by judging whether an error reduction degree of the current spiking neural network after updating the parameter weight is stabilized within a preset range, it is judged whether the current spiking neural network converges; or
by judging whether an error of the current spiking neural network after updating the parameter weight is less than an error threshold, it is judged whether the current spiking neural network converges; or
by a verification set in the dynamic visual data set, it is judged whether the current spiking neural network after updating the parameter weight converges.

In some embodiments of the present disclosure, the process that the raw visual data is processed by using the dynamic visual sensor simulation method to obtain spiking sequences corresponding to the raw visual data, includes:
traversing is started from a first frame of video frame image of the raw visual data, and an ith frame of video frame image is converted from an RGB color space to a grayscale space, to obtain converted current video frame data;
it is judged whether i is equal to 1;
when i is equal to 1, all floating-point data of the current video frame data is assigned to a first output channel of a first time step of simulation data, and the current video frame data is taken as a previous video frame;
when i is not equal to 1, the first output channel and a second output channel are respectively assigned according to a grayscale difference value between the current video frame and the previous video frame and a preset threshold, and the current video frame data is taken as the previous video frame;
the value of i is added by 1, and it is judged whether the updated i is less than N;
when i is less than N, the method returns to execute the step that the ith frame of video frame image is converted from an RGB color space to a grayscale space; and
when i is not less than N, the operation ends, to obtain spiking sequences composed of the first output channel and the second output channel; where N represents the total number of video frame images contained in the raw visual data.

In some embodiments of the present disclosure, the first output channel and the second output channel are respectively assigned according to the grayscale difference value between the current video frame and the previous video frame and the preset threshold, includes:
for each pixel, a grayscale difference value between the current video frame and the previous video frame at the pixel is calculated;
the grayscale difference value is compared with the preset threshold, and when the grayscale difference value is greater than the preset threshold, 1 is assigned to a position corresponding to the first output channel; and when the grayscale difference value is less than the preset threshold, 1 is assigned to a position corresponding to the second output channel.

In some embodiments of the present disclosure, the spiking neural network includes a feature extraction component, a voting neuronal population component and an emotion mapping component;
the process that the pre-established spiking neural network emotion recognition model is trained by using the dynamic visual data set, to obtain the trained spiking neural network emotion recognition model, includes:
a parameter weight of the pre-established spiking neural network is initialized;
the dynamic visual data set is used as an input to the current spiking neural network, and an output frequency of the voting neuronal population of each emotion category is obtained via forward propagation of the network;
regarding each emotion category, an error between the output frequency and a real label of a corresponding emotion category is calculated;
a gradient corresponding to the parameter weight is calculated according to the error, and the parameter weight of the current spiking neural network is updated by using the gradient;
it is judged whether the current spiking neural network after updating the parameter weight converges, when the current spiking neural network after updating the parameter weight converges, the training ends, to obtain a trained spiking neural network emotion recognition model; and when the current spiking neural network after updating the parameter weight does not converge, the method returns to execute the step that the dynamic visual data set is used as the input to the current spiking neural network and the output frequency of the voting neuronal population of each emotion category is obtained via forward propagation of the network, so as to perform next round of training.

In some embodiments of the present disclosure, the spiking neural network further includes: a feature extraction component, wherein the feature extraction component includes a single forward extraction unit composed of convolution, normalization, Parametric Leaky-Integrate and Fire (PLIF) model and average pooling, and a network unit composed of two fully-connected layers and two PLIF, which are arranged at intervals.

Embodiments of the present disclosure further provide a method for training emotion recognition model, including:
an emotion recognition-based dynamic visual data set is pre-established, and a pre-established spiking neural network emotion recognition model is trained by using the dynamic visual data set, to obtain a trained spiking neural network emotion recognition model; or
test sets of a plurality of emotion categories are acquired; and test training is performed on the pre-established spiking neural network emotion recognition model by using the test sets, to obtain a trained spiking neural network emotion recognition model.

Embodiments of the present disclosure further provide an apparatus for recognizing emotion, including:
an acquisition component, configured to acquire to-be-recognized spiking sequences corresponding to video information; and
a recognition component, configured to recognize the to-be-recognized spiking sequences by using a pre-established spiking neural network emotion recognition model, so as to obtain a corresponding emotion category.

In some embodiments of the present disclosure, the apparatus further includes:
a training component, configured to train the spiking neural network emotion recognition model, to obtain a trained spiking neural network emotion recognition model.

In some embodiments of the present disclosure, the training component includes:
a test set acquisition component, configured to acquire test sets of a plurality of emotion categories after a first establishment component pre-establishes the spiking neural network emotion recognition model; and
a first training component, configured to perform test training on the pre-established spiking neural network emotion recognition model by using the test sets acquired by the test set acquisition component, to obtain a trained spiking neural network emotion recognition model.

In some embodiments of the present disclosure, the training component includes:
an establishment component, configured to pre-establish an emotion recognition-based dynamic visual data set; and
a second training component, configured to train the pre-established spiking neural network emotion recognition model by using the dynamic visual data set, to obtain a trained spiking neural network emotion recognition model.

In some embodiments of the present disclosure, the establishment component includes: a spiking sequence acquisition component, a data set establishment component, and at least one of a simulation processing component and a spiking sequence acquisition component, wherein
a data acquisition component is configured to acquire emotion recognition-based raw visual data;
the simulation processing component is configured to perform simulation processing on the raw visual data by using a dynamic visual sensor simulation method, to obtain a plurality of spiking sequences corresponding to the raw visual data;
a first spiking sequence acquisition component is configured to directly acquire a plurality of spiking sequences corresponding to the raw visual data by using a dynamic visual camera; and
the data set establishment component is configured to establish an emotion recognition-based dynamic visual data set on the basis of the plurality of spiking sequences obtained by the simulation processing component or the spiking sequence acquisition component.

In some embodiments of the present disclosure, the simulation processing component includes:
a traversing component, configured to sequentially traverse N frames of video frame images in raw dynamic video data, where N represents the total number of video frame images contained in the raw visual data;
a first conversion component, configured to convert, when the traversing component traverses to a current ith frame, a video frame image of the current ith frame from an RGB color space to a grayscale space, and take the converted video frame data as current video frame data, where the numerical range of i is from 1 to N; and
a first assignment component, configured to assign, when the value of i is equal to 1, all floating-point data of the current video frame data to a first output channel of a first time step of simulation data, to obtain a spiking sequence composed of the first output channel.

In some embodiments of the present disclosure, the simulation processing component further includes:
a second assignment component, configured to respectively assign, when i is not equal to 1, the first output channel and a second output channel according to a grayscale difference value between the current video frame and the previous video frame and a preset threshold, and take the current video frame data as the previous video frame;
a first update component, configured to update the value of i by adding 1; and
a second conversion component, further configured to execute, when i updated by the update component is less than N, the step that a video frame image of the current ith frame is converted from the RGB color space to the grayscale space, and the converted video frame data is taken as current video frame data.

In some embodiments of the present disclosure, the simulation processing component further includes:
a second spiking sequence acquisition component, configured to complete traversing of the N frames of video frame images in the raw dynamic video data when i updated by the update component is not less than N, to obtain spiking sequences composed of the first output channel and the second output channel.

In some embodiments of the present disclosure, the assignment component includes: a first calculation component, and at least one of a first position assignment component and a first position assignment component, wherein
the first calculation component is configured to calculate, for each pixel, a grayscale difference value between the current video frame and the previous video frame at the pixel;
the first position assignment component is configured to assign 1 to a position corresponding to the first output channel when the grayscale difference value is greater than the preset threshold; and
the second position assignment component is configured to assign 1 to a position corresponding to the second output channel when the grayscale difference value is less than the preset threshold.

In some embodiments of the present disclosure, the spiking neural network includes a voting neuronal population;
the second training component includes:
an initialization component, configured to initialize a parameter weight of the pre-established spiking neural network emotion recognition model;
a first propagation component, configured to use the dynamic visual data set as an input to the current spiking neural network in the spiking neural network emotion recognition model, and obtain an output frequency of the voting neuronal population of each emotion category via forward propagation of the current spiking neural network;
an error calculation component, configured to calculate, regarding each emotion category, an error between the output frequency of the voting neuronal population of the emotion category and a real label of a corresponding emotion category;
a gradient calculation component, configured to calculate a gradient corresponding to the parameter weight according to the error;
a second update component, configured to update the parameter weight of the current spiking neural network by using the gradient calculated by the gradient calculation component;
a judgment component, configured to judge whether the current spiking neural network after the parameter weight is updated by the update component converges; and
a model training determination component, configured to stop training when the judgment component judges that the current spiking neural network after updating the parameter weight has converged, to obtain a trained spiking neural network emotion recognition model.

In some embodiments of the present disclosure, the second training component further includes:
a second propagation component, configured to use, when the judgment component judges that the current spiking neural network after updating the parameter weight has not converged, the dynamic visual data set as an input to the current spiking neural network in the spiking neural network emotion recognition model, and obtain an output frequency of the voting neuronal population of each emotion category via forward propagation of the current spiking neural network.

In some embodiments of the present disclosure, the judgment component at least includes one of the following:
a first judgment component, configured to judge whether the current spiking neural network converges by judging whether current training number of times of the current spiking neural network after updating the parameter weight reaches a preset number of times;
a second judgment component, configured to judge whether the current spiking neural network converges by judging whether an error reduction degree of the current spiking neural network after updating the parameter weight is stabilized within a preset range;
a third judgment component, configured to judge whether the current spiking neural network converges by judging whether an error of the current spiking neural network after updating the parameter weight is less than an error threshold; and
a fourth judgment component, configured to judge whether the current spiking neural network after updating the parameter weight converges by a verification set in the dynamic visual data set.

In some embodiments of the present disclosure, the spiking neural network further includes: a feature extraction component, wherein the feature extraction component includes a single forward extraction unit composed of convolution, normalization, Parametric Leaky-integrate and Fire (PLIF) model and average pooling, and a network unit composed of two fully-connected layers and two PLIF, which are arranged at intervals.

Embodiments of the present disclosure further provide an apparatus for training emotion recognition model, including:
an establishment component, configured to pre-establish an emotion recognition-based dynamic visual data set; and
a training component, configured to train a pre-established spiking neural network emotion recognition model by using the dynamic visual data set, to obtain a trained spiking neural network emotion recognition model.

Embodiments of the present disclosure further provide an apparatus for training emotion recognition model, including:
an acquisition component, configured to acquire test sets of a plurality of emotion categories; and
a training component, configured to perform test training on a pre-established spiking neural network emotion recognition model by using the test sets, to obtain a trained spiking neural network emotion recognition model.

Embodiments of the present disclosure further provide an apparatus for recognizing emotion, including:
a memory, for storing a computer program; and
a processor, for implementing the method for recognizing emotion or the method for training emotion recognition model when executing the computer program.

Embodiments of the present disclosure further provide an electronic device, including:
a memory, for storing a computer program; and
a processor, for implementing the method for recognizing emotion or the method for training emotion recognition model when executing the computer program.

Embodiments of the present disclosure further provide a computer non-transitory readable storage medium; the computer non-transitory readable storage medium stores a computer program, which when executed by a processor, implements the method for recognizing emotion or the method for training emotion recognition model.

Some embodiments of the present disclosure further provide a computer program product, including a computer program or instructions, which when executed by a processor, implement the convolution feature caching method or the method for recognizing emotion or the method for training emotion recognition model.

The technical solutions provided in the embodiments of the present disclosure at least bring about the following beneficial effects:

In the embodiments of the present disclosure, first, to-be-recognized spiking sequences corresponding to video information are acquired; and then the to-be-recognized spiking sequences are recognized by using a spiking neural network emotion recognition model, so as to obtain a corresponding emotion category. That is to say, in the embodiments of the present disclosure, the acquired to-be-recognized spiking sequences may be recognized by the spiking neural network emotion recognition model, so as to obtain a corresponding emotion category. Namely, some embodiments of the present disclosure may recognize an emotion category on the basis of video information, so that the ways for emotion recognition increase, which is beneficial to better achieve emotion recognition. Further, in the embodiments of the present disclosure, a spiking neural network may also be trained by pre-establishing a dynamic visual data set, to obtain a spiking neural network emotion recognition model; and then to-be-recognized spiking sequences corresponding to video information are acquired, the to-be-recognized spiking sequences are inputted into the spiking neural network emotion recognition model, and then the to-be-recognized spiking sequences are recognized by using the spiking neural network emotion recognition model, so as to obtain a corresponding emotion category. That is to say, in the embodiments of the present disclosure, a spiking neural network may be trained by pre-establishing a dynamic visual data set, and the to-be-recognized spiking sequences corresponding to the video information are recognized by using the trained spiking neural network emotion recognition model, so as to obtain a corresponding emotion category, so that the ways for emotion recognition increase, which is beneficial to better achieve emotion recognition of video information.

### BRIEF DESCRIPTION OF THE DRAWINGS

In order to describe the technical solutions in the embodiments of the present disclosure or in the related art more clearly, hereinafter, accompanying drawings requiring to be used in the embodiments of the present disclosure or the related art will be introduced briefly. Apparently, the accompanying drawings in the following description merely relate to embodiments of the present disclosure, and for a person of ordinary skill in the art, other accompanying drawings can also be obtained according to these accompanying drawings without involving any inventive effort.

FIG. 1 is a schematic flowchart of a method for recognizing emotion provided according to embodiments of the present disclosure.

FIG. 2 is a schematic flowchart of a method for converting raw dynamic visual data into a pulse sequence provided according to embodiments of the present disclosure;

FIG. 3 is a schematic structural diagram of a spiking neural network provided according to embodiments of the present disclosure;

FIG. 4 is a schematic flowchart of a method for establishing a spiking neural network emotion recognition model provided according to embodiments of the present disclosure;

FIG. 5 is a flowchart of a method for training emotion recognition model provided according to embodiments of the present disclosure;

FIG. 6 is another flowchart of a method for training emotion recognition model provided according to embodiments of the present disclosure;

FIG. 7 is a schematic structural diagram of an apparatus for recognizing emotion provided according to embodiments of the present disclosure;

FIG. 8 is another schematic structural diagram of an apparatus for recognizing emotion provided according to embodiments of the present disclosure;

FIG. 9 is a structural block diagram of an apparatus for training emotion recognition model provided according to embodiments of the present disclosure;

FIG. 10 is another structural block diagram of an apparatus for training emotion recognition model provided according to embodiments of the present disclosure;

FIG. 11 is a block diagram of an electronic device provided according to embodiments of the present disclosure; and

FIG. 12 is a block diagram of an apparatus for emotion recognition or emotion recognition model training provided according to embodiments of the present disclosure.

### DETAILED DESCRIPTION OF THE EMBODIMENTS

Embodiments of the present disclosure provide a method for recognizing emotion, a method for training emotion recognition model, apparatuses, a computer non-transitory readable storage medium, and a computer program product, which can recognize an emotion category on the basis of video information in a use process, so that the ways for emotion recognition increase, which is beneficial to better achieve emotion recognition.

To make the objects, technical solutions and advantages of the embodiments of the present disclosure clearer, hereinafter, the technical solutions in embodiments of the present disclosure will be described clearly and thoroughly in combination with the accompanying drawings in the embodiments of the present disclosure. Apparently, the embodiments as described are merely some rather than all of the embodiments of the present disclosure. All other embodiments obtained by a person of ordinary skill in the art on the basis of the embodiments of the present disclosure without any inventive effort shall all fall within the scope of protection of the present disclosure.

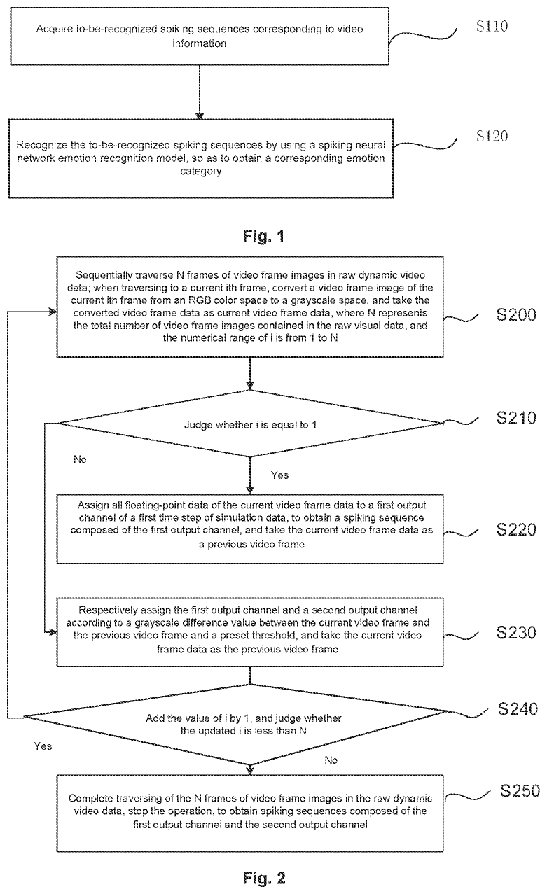

Please refer to FIG. 1, FIG. 1 is a schematic flowchart of a method for recognizing emotion provided according to embodiments of the present disclosure. The method includes:
S110: to-be-recognized spiking sequences corresponding to video information are acquired.

In some embodiments, the acquisition of the to-be-recognized spiking sequences corresponding to video information can use a dynamic visual camera to directly acquire the to-be-recognized spiking sequences corresponding to the video information, and can also use simulation data of the video information. It should be noted that, as the cost of the dynamic visual camera is high, in the embodiments of the present disclosure, in order to reduce costs, video information may be acquired first, and then simulation is performed on the video information to obtain corresponding to-be-recognized spiking sequences.
S120: the to-be-recognized spiking sequences are recognized by using a spiking neural network emotion recognition model, so as to obtain a corresponding emotion category. The spiking neural network emotion recognition model is obtained by training a spiking neural network by using a pre-established dynamic visual data set.

In this step, the specific process of recognizing the to-be-recognized spiking sequences includes: the to-be-recognized spiking sequences are inputted into the spiking neural network emotion recognition model, and the to-be-recognized spiking sequences are recognized by the spiking neural network emotion recognition model, so as to obtain a corresponding emotion category.

The spiking neural network emotion recognition model in this step is pre-established. In some embodiments of the present disclosure, after the spiking neural network emotion recognition model is established and before the to-be-recognized spiking sequences are recognized, the pre-established spiking neural network emotion recognition model is trained first to obtain a trained spiking neural network emotion recognition model. The specific training process includes:

One training mode: test sets of a plurality of emotion categories are acquired; and test training is performed on a pre-established spiking neural network emotion recognition model by using the test sets, to obtain a trained spiking neural network emotion recognition model.

Another training mode: an emotion recognition-based dynamic visual data set is pre-established; and a pre-established spiking neural network emotion recognition model is trained by using the dynamic visual data set, to obtain a trained spiking neural network emotion recognition model.

It can be understood that, in the embodiments of the present disclosure, the emotion recognition-based dynamic visual data set and the spiking neural network are pre-established, and then the spiking neural network is trained by using the dynamic visual data set, so as to obtain the trained spiking network emotion recognition model. The process of pre-establishing the dynamic visual data set may include:
emotion recognition-based raw visual data is acquired;
simulation processing is performed on the raw visual data by using a dynamic visual sensor simulation method, to obtain a plurality of spiking sequences corresponding to the raw visual data; and
an emotion recognition-based dynamic visual data set is established on the basis of the plurality of spiking sequences.

It should be noted that, in practical applications, the dynamic visual camera may be used to directly acquire the to-be-recognized spiking sequences corresponding to the video information, but the cost of the dynamic visual camera is high. In the embodiments of the present disclosure, in order to further reduce costs, the emotion recognition-based raw visual data may be collected first by an ordinary video collection device, and then the dynamic visual sensor simulation method is used to perform simulation on the raw visual data to obtain spiking data corresponding to the raw visual data, thereby converting the raw visual data into spiking data and reducing device costs. It can be understood that spiking sequences corresponding to one piece of raw visual data are actually a spiking sequence array constituted by spiking sequences at all pixel positions of all video pictures in the whole raw visual data. In the embodiments of the present disclosure, the spiking sequence array is simply referred to as spiking sequences corresponding to the raw visual data; and in practical applications, simulation processing is performed on a plurality of pieces of raw visual data by using the dynamic visual sensor simulation method, so as to obtain a plurality of spiking sequences; and the emotion recognition-based dynamic visual data set is established on the basis of the plurality of spiking sequences.

Still further, please refer to FIG. 2, the process that simulation processing is performed on the raw visual data by using the dynamic visual sensor simulation method, to obtain a plurality of spiking sequences corresponding to the raw visual data, may include:
S200: N frames of video frame images in the raw dynamic video data are sequentially traversed; when traversing to a current ith frame, a video frame image of the current ith frame is converted from an RGB color space to a grayscale space, and the converted video frame data is taken as current video frame data, where N represents the total number of video frame images contained in the raw visual data, and the numerical range of i is from 1 to N. That is, traversing is started from a first frame of video frame image of the raw visual data, and an ith frame of video frame image is converted from the RGB color space to the grayscale space, to obtain converted current video frame data; wherein RGB represents three primary colors of image colors, i.e. red, green and blue in English.
S210: it is judged whether i is equal to 1; when i is equal to 1, the method proceeds to S220; and when i is not equal to 1, the method proceeds to S230;
S220: all floating-point data of the current video frame data is assigned to a first output channel of a first time step of simulation data, to obtain a spiking sequence composed of the first output channel, and the current video frame data is taken as a previous video frame;
S230: the first output channel and a second output channel are respectively assigned according to a grayscale difference value between the current video frame and the previous video frame and a preset threshold, and the current video frame data is taken as the previous video frame;
S240: the value of i is added by 1, and it is judged whether the updated i is less than N; when i is less than N, the method returns to execute the step that the video frame image of the current ith frame is converted from the RGB color space to the grayscale space, i.e. S200; when i is not less than N, the method proceeds to S250; and
S250: traversing of the N frames of video frame images in the raw dynamic video data is completed, and the operation ends, to obtain spiking sequences composed of the first output channel and the second output channel.

It should be noted that the feature of dynamic vision is that information captured by the camera is no longer all information in the whole scenario, especially in cases where scenario change is not large, which may greatly reduce the amount of data to be recorded and transmitted. In the embodiments of the present disclosure, grayscale information between adjacent picture frames in video data is differentiated, and the differentiated result is judged according to the preset threshold, so as to determine whether it is necessary to record data to complete simulation conforming to dynamic visual characteristics.

Recording features of the dynamic visual data are that only changes are recorded, and are defined by formalized symbol descriptions, which are generally represented by E[xᵢ, yᵢ, tᵢ, pᵢ], where E denotes an event, the event only has two attributes: occurring and not occurring, (xᵢ, yᵢ) denotes the position where the event occurs in a scenario, tᵢ denotes a time when the event occurs, and pᵢ denotes a polarity of occurrence of the event. For example, for a change situation of light intensity in a scenario recorded in an event, the change of light intensity has two directions: changing from strong to weak, or changing from weak to strong, and the two changes both represent the occurrence of the event, and in order to distinguish these two events, the dimension of polarity is defined. The method provided in the embodiments of the present disclosure is to generate dynamic visual data in a similar form by computer simulation, and herein continuous recording of a scenario is represented by using video data. As a task of the present system is emotion recognition, data used herein is raw visual data for emotion recognition. It is assumed that a segment of raw visual data contains N frames of video frame images in total, and these video frame images are inputs to the dynamic visual sensor simulation method, and calculation may be performed according to the following simulation steps to generate simulated dynamic visual data: In practical applications, simulation visual data representation of all-zero numerical values may be represented as: E[xᵢ, yᵢ, tᵢ, pᵢ], where the numerical range of i is from 1 to N, and the magnitude of E is H×W×N×2, where H and W are respectively the height and width of a video frame image; an intermediate variable is initialized and data of a previous frame is recorded, and marked as Fₚᵣₑ, and the sensitivity between frames (i.e. the preset threshold) is defined as Sens, and a simulation event occurs when the difference between two frames exceeds a sensitivity.

In some embodiments, in the embodiments of the present disclosure, in the process of converting the raw dynamic video data into the spiking sequences, N frames of video frame images in the entire raw dynamic video data may be traversed starting from a first frame of video frame image. For example, for the current ith frame of video frame image, the video frame image is converted from an RGB color space to a grayscale space, represented by V_{gray}, and the converted video frame data is used as the current video frame data, and then the size of i is judged.

In some embodiments, when i is equal to 1, that is, for the current video frame data corresponding to a first frame of video frame image, all floating-point data of the current video frame data is assigned to a first output channel of a first time step of simulation data (which may be achieved by codes E[:,:,i,0]←V_{gray}), and the current video frame data is taken as a previous video frame (which may be achieved by codes Fₚᵣₑ←V_{gray}).

When i is not equal to 1, the first output channel and a second output channel are respectively assigned according to a grayscale difference value between the current video frame and the previous video frame and a preset threshold, and the current video frame data is taken as the previous video frame, and the step that the value of i is added by 1 in S240 is executed. This process may be implemented by the following method:
for each pixel, a grayscale difference value between the current video frame and the previous video frame at the pixel is calculated; and
the grayscale difference value is compared with the preset threshold, and when the grayscale difference value is greater than the preset threshold, 1 is assigned to a position corresponding to the first output channel; and when the grayscale difference value is less than the preset threshold, 1 is assigned to a position corresponding to the second output channel.

In some embodiments, in the embodiments of the present disclosure, for each pixel in the current video frame image, a grayscale difference value between the current video frame and the previous video frame at the pixel is calculated; and then the grayscale difference value is compared with the preset threshold, and assignment is performed regarding two different types of events according to the comparison result. In some embodiments, when the grayscale difference value is greater than the preset threshold, 1 is assigned to a position corresponding to the first output channel, which may be achieved by codes E[:,:,i,0]←int(V_{gray}−Fₚᵣₑ>Sens); and when the grayscale difference value is less than the preset threshold, 1 is assigned to a position corresponding to the second output channel, which may be achieved by codes E[:,:,i,1]←int(V_{gray}−Fₚᵣₑ<Sens).

In addition, in the embodiments of the present disclosure, after the value of i is added by 1, it is judged whether the updated i is less than N; when less than N, the method returns to execute the step that the video frame image of the ith frame is converted from the RGB color space to the grayscale space, so as to continue processing a next video frame image; and when not less than N, the operation ends, it indicates that all the N video frame images are processed, so as to obtain spiking sequences composed of the first output channel and the second output channel.

It should also be noted that, the spiking neural network transfers information in a spiking manner, and the spiking transfer process itself is not derivable, such that gradient back propagation may not be used for synaptic weight turnover; and in an optimization process, in order to avoid manually setting some hyper-parameters (e.g. a membrane time constant T of a neuron), a person skilled in the art recently proposed that the membrane time constant T of a neuron may be integrated into joint update of a whole model synaptic weight, and this model is referred to as PLIF (Parametric Leaky-Integrate and Fire model) Joint optimization is more convenient than manual setting, and may perform optimization to obtain better synaptic weights. In the embodiments of the present disclosure, PLIF is used as layers in the SNN to construct an emotion recognition SNN model, as follows:

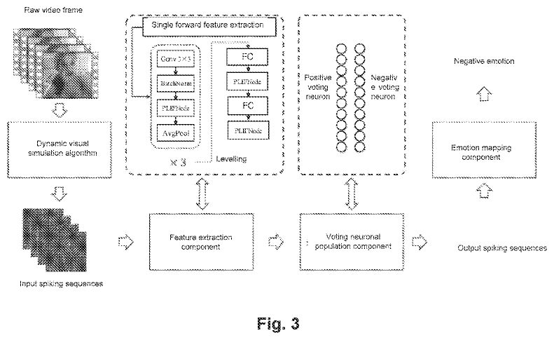

Please refer to FIG. 3, the spiking neural network includes a feature extraction component, a voting neuronal population component and an emotion mapping component.

It should be noted that, in FIG. 3, raw video frames are subjected to a dynamic visual simulation algorithm (i.e. the dynamic visual sensor simulation method) to obtain spiking sequences, the spiking sequences serving as inputs to the spiking neural network; the feature extraction component in the spiking neural network functions to perform feature extraction from the input spiking sequences to obtain spiking features with stronger expressivity; the voting neuronal population component functions to simulate working features of neuron populations in the brain, and a plurality of neurons are used to represent a decision trend; and the emotion mapping component decides a mapping result of final emotion classification on the basis of the frequency at which the neuronal population emits spikes.

In some embodiments, the feature extraction component in the embodiments of the present disclosure simulates a manner in which brain neurons process information, and abstracts a convolution operation and a pooling operation; in addition, in the embodiments of the present disclosure, a spiking neuron model PLIF is used during information transfer. The feature extraction component includes a single forward extraction unit composed of convolution, normalization, Parametric Leaky-Integrate and Fire (PLIF) model and average pooling, and a network unit composed of two fully-connected layers and two PLIF, which are arranged at intervals. In some embodiments, an operation of single forward feature extraction includes: a convolution operation with a convolution kernel of 3×3 (e.g. Conv 3×3 in FIG. 3), a normalization operation (e.g. BatchNorm in FIG. 3), PLIF (e.g. PLIFNode in FIG. 3) and average pooling (e.g. AvgPool in FIG. 3); this calculation process may be repeated multiple times (for example, 3 times), input spikes are compressed to a certain extent, the number of spiking features is reduced, and the discriminability of the spiking features is improved, in which the window size of the average pooling may be 2×2. In particular, in the embodiments of the present disclosure, in order to further reduce the number of spiking features, the feature extraction module further uses a manner of two fully-connected layers to perform further effective feature compression. Since the output of a conventional fully-connected layer is floating-point numbers, here representing a membrane potential, it is necessary to add PLIF layers to convert the floating-point numbers into a spiking transfer form, that is, two fully-connected layers and PLIF arranged at intervals are adopted, the specific sequence is a fully-connected layer 1, PLIF1, a fully-connected layer 2 and PLIF2; wherein the number of neurons included in the fully-connected layer 1 and the PLIF1 may be flexibly set, but the number of neurons in the two may be consistent, for example, both set to 1000; and the number of neurons included in the fully-connected layer 2 and the PLIF2 may be set according to the specific number of outputted emotion categories, e.g., two categories, and the number of neurons may be set to 20. The specific numerical values may all be determined according to actual needs, and will not be limited in the embodiments of the present disclosure.

Regarding the voting neuronal population module, the decision of neurons in the brain is based on collaborative work of a plurality of neurons, and therefore in the embodiments of the present disclosure, with regard to the final number of emotion recognition categories, a certain emotion category is recognized by using a plurality of neurons forming a population. In some embodiments, ten neurons may be used to form a population corresponding to one category, and in the embodiments of the present disclosure, explanation is made by using examples of recognition of two emotion categories. That is to say, ten neurons are used to cooperatively decide whether it is ultimately an emotion category corresponding to the population of neurons, and the total number is the number of emotion categories multiplied by ten, and the voting neuronal population module outputs spiking sequences.

Regarding the emotion mapping module, the emotion mapping module may map the spiking sequences outputted by the voting neuronal population module to a final emotion category. In some embodiments, a spiking sequence emitted by each neuron may correspond to one frequency, and the frequency may be used as one of output mappings of the neuron, and then, the frequencies of all the neurons in a neuronal population of a current category are averaged, and thus each neuronal population corresponds to a final frequency, a larger frequency indicates that the corresponding emotion category is activated, and the emotion category corresponding to the neuronal population with the largest frequency is outputted.

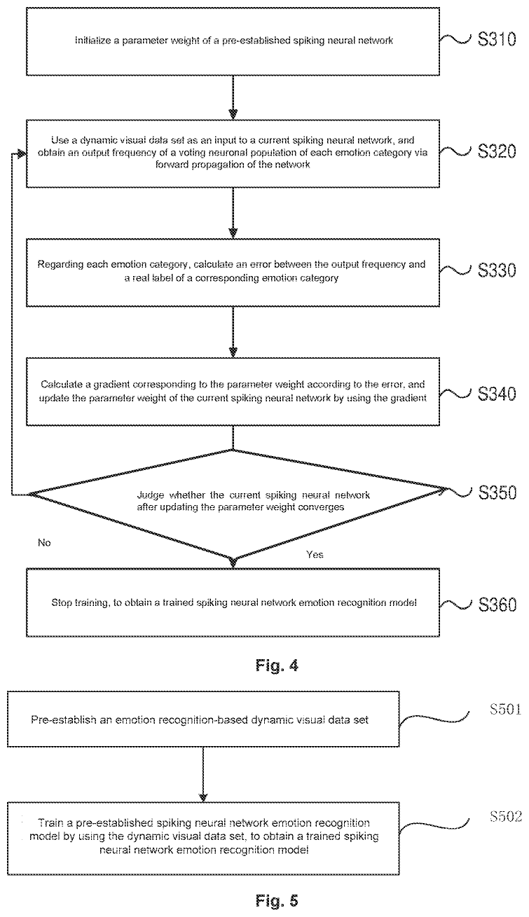

Please refer to FIG. 4, the process that the pre-established spiking neural network emotion recognition model is trained by using the dynamic visual data set, to obtain a trained spiking neural network emotion recognition model, will be introduced in detail below, the process may include:

S310: a parameter weight of a pre-established spiking neural network is initialized; in some embodiments, a parameter weight of the pre-established spiking neural network emotion recognition model is initialized.

It should be noted that, in actual applications, the dynamic visual data set may be divided into three parts, which are respectively a training set, a verification set and a test set; and the spiking neural network emotion recognition model is pre-constructed, the spiking neural network emotion recognition model is as described above, and will not be repeated in the embodiments of the present disclosure. In some embodiments, the parameter weight of the spiking neural network emotion recognition model is initialized first.

S320: the dynamic visual data set is used as an input to a current spiking neural network, and an output frequency of a voting neuronal population of each emotion category is obtained via forward propagation of the network. In some embodiments, the dynamic visual data set is used as an input to the current spiking neural network in the spiking neural network emotion recognition model, and the output frequency of the voting neuronal population of each emotion category is obtained via forward propagation of the current spiking neural network.

In this step, in each round of training process, the current spiking neural network is determined on the basis of a current parameter weight, and the training set in the dynamic visual data set is taken as an input to the current spiking neural network in the spiking neural network emotion recognition model; and then, via forward propagation of the current spiking neural network, the output frequency of the voting neuronal population of each emotion category is obtained. For one voting neuronal population, an average value of output frequencies of various voting neurons in the voting neuronal population may be calculated, to obtain the output frequency of the voting neuronal population.

S330: regarding each emotion category, an error between the output frequency and a real label of a corresponding emotion category is calculated. In some embodiments, regarding each emotion category, an error between the output frequency of the voting neuronal population of the emotion category and a real label of a corresponding emotion category is calculated.

In this step, since each voting neuronal population corresponds to one emotion category, the error may be calculated according to the output frequency of the voting neuronal population and the real label of the corresponding emotion category. In the embodiments of the present disclosure, a mean square error (MSE) may be calculated.

S340: a gradient corresponding to the parameter weight is calculated according to the error, and the parameter weight of the current spiking neural network is updated by using the gradient.

In some embodiments, a final average error may be obtained by calculation according to the error corresponding to each voting neuronal population, then a gradient corresponding to the parameter weight is calculated according to the average error, and then the parameter weight of the current spiking neural network in the spiking neural network emotion recognition model is updated by using the gradient.

It should be noted that, in practical applications, a Stochastic Gradient Descent (SGD) algorithm may be used, and also, other gradient descent-based parameter optimization methods may also be selected to update the parameter weight, including but not limited to, methods such as RMSprob (Root Mean Square propagation), Adagrad (Adaptive Subgradient), Adam (Adaptive Moment Estimation), Adamax (Adam variant based on infinite number), ASGD (Averaged Stochastic Gradient Descent) and RMSprob; and using which method may be determined according to actual situations, which is not limited in the embodiments of the present disclosure.

S350: it is judged whether the current spiking neural network after updating the parameter weight converges; when the current spiking neural network after updating the parameter weight converges, the method proceeds to S360; and when the current spiking neural network after updating the parameter weight does not converge, the method returns to execute S320 to perform next round of training, until the trained spiking neural network emotion recognition model is obtained.

In some embodiments, after the parameter weight is updated, the current spiking neural network in the spiking neural network emotion recognition model is determined on the basis of the updated parameter weight; and then the convergence of the current spiking neural network may be further judged according to the verification set in the dynamic visual data set; and when the current spiking neural network has converged, the method proceeds to S360 and the operation ends, and a spiking neural network emotion recognition model based on the latest parameter weight is obtained. Also, test training may be performed on the spiking neural network emotion recognition model by using the acquired test sets of a plurality of emotion categories, and a corresponding emotion category is outputted, so as to obtain the trained spiking neural network emotion recognition model. When the current spiking neural network has not converged, the method may return to S320 to re-use the training set to perform next round of training on the updated current spiking neural network, so as to re-update the parameter weight until the updated current spiking neural network converges.

S360: the training ends, to obtain a trained spiking neural network emotion recognition model. In some embodiments, when it is judged that the current spiking neural network after updating the parameter weight has converged, the training ends, to obtain a trained spiking neural network emotion recognition model.

It should be noted that in practical applications, there may be a plurality of methods for judging whether the current spiking neural network converges, for example, by judging whether the current training number of times reaches a preset number of times, when the current training number of times reaches a preset number of times, the current spiking neural network has converged, and when the current training number of times does not reaches a preset number of times, the current spiking neural network has not converged. The judgment may also be performed by judging whether an error reduction degree of the current spiking neural network is stabilized within a preset range; when the error reduction degree of the current spiking neural network is stabilized within the preset range, the current spiking neural network has converged, and when the error reduction degree of the current spiking neural network is not stabilized within the preset range, the current spiking neural network has not converged. Further, it may be judged whether the current spiking neural network converges by judging whether an error based on the current spiking neural network is less than an error threshold; when the error based on the current spiking neural network is less than an error threshold, the current spiking neural network has converged, and when the error based on the current spiking neural network is not less than an error threshold, the current spiking neural network has not converged.

Hence, in the embodiments of the present disclosure, a spiking neural network is trained by a pre-established dynamic visual data set to obtain a spiking neural network emotion recognition model and then to-be-recognized spiking sequences corresponding to video information are acquired; the to-be-recognized spiking sequences are inputted into the spiking neural network emotion recognition model, and the to-be-recognized spiking sequences are recognized by the spiking neural network emotion recognition model, so as to obtain a corresponding emotion category. Some embodiments of the present disclosure may recognize an emotion category on the basis of video information in a use process, so that the ways for emotion recognition increase, which is beneficial to better achieve emotion recognition.

In some embodiments of the present disclosure, please further please refer to FIG. 5, FIG. 5 is a flowchart of a method for training emotion recognition model provided according to embodiments of the present disclosure, including:
S501: an emotion recognition-based dynamic visual data set is pre-established; and
S502: a pre-established spiking neural network emotion recognition model is trained by using the dynamic visual data set, to obtain a trained spiking neural network emotion recognition model.

It should be noted that, for specific implementation process of each step in some embodiments, reference may be made to the implementation process of corresponding steps in the embodiments above for details, and they will not be repeated herein.

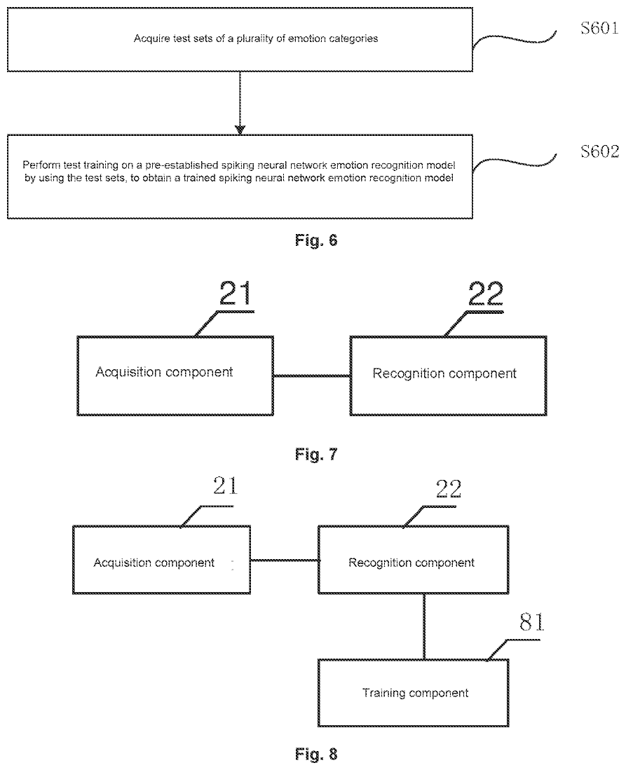

In some embodiments of the present disclosure, please further refer to FIG. 6, FIG. 6 is another flowchart of a method for training emotion recognition model provided according to embodiments of the present disclosure, including:
S601: test sets of a plurality of emotion categories are acquired; and
S602: test training is performed on a pre-established spiking neural network emotion recognition model by using the test sets, to obtain a trained spiking neural network emotion recognition model.

It should be noted that, for specific implementation process of each step in some embodiments, reference may be made to the implementation process of corresponding steps in the embodiments above for details, and they will not be repeated herein.

On the basis of the embodiments above, embodiments of the present disclosure further provide an apparatus for recognizing emotion. For details, please refer to FIG. 7. The apparatus includes:
an acquisition module 21, configured to acquire to-be-recognized spiking sequences corresponding to video information; and
a recognition module 22, configured to recognize the to-be-recognized spiking sequences by using a spiking neural network emotion recognition model, so as to obtain a corresponding emotion category.

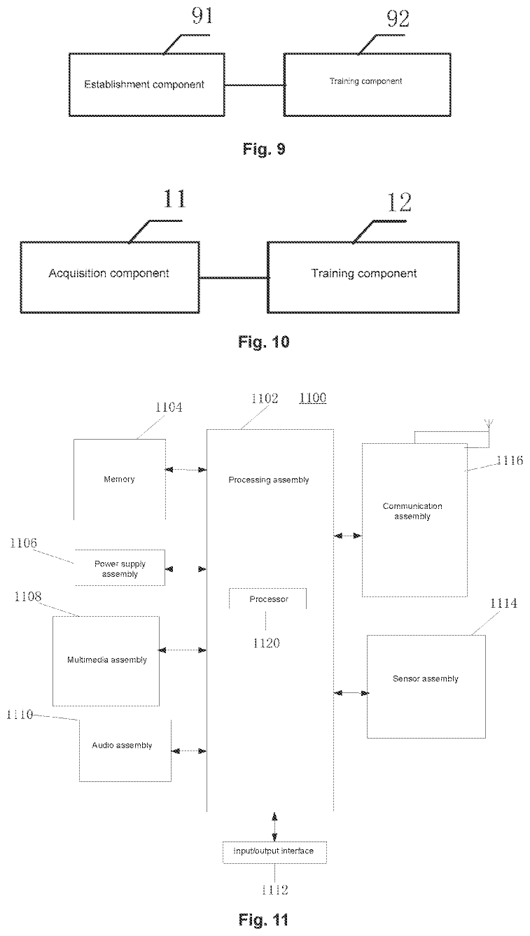

In some embodiments of the present disclosure, in some other embodiments, based on the embodiments above, the apparatus further includes: a training module 801, a schematic structural diagram thereof is as shown in FIG. 8, wherein
the training module 81 is configured to train the spiking neural network emotion recognition model, to obtain a trained spiking neural network emotion recognition model.

In some embodiments of the present disclosure, in some other embodiments, based on the embodiments above, the training module includes: a test set acquisition module and a first training module, wherein
the test set acquisition module is configured to acquire test sets of a plurality of emotion categories after a first establishment module pre-establishes the spiking neural network emotion recognition model; and
the first training module is configured to perform test training on the pre-established spiking neural network emotion recognition model by using the test sets acquired by the test set acquisition module, to obtain a trained spiking neural network emotion recognition model.

In some embodiments of the present disclosure, in some other embodiments, based on the embodiments above, the training module includes: an establishment module and a second training module,
the establishment module is configured to pre-establish an emotion recognition-based dynamic visual data set; and
the second training module is configured to train the pre-established spiking neural network emotion recognition model by using the dynamic visual data set, to obtain a trained spiking neural network emotion recognition model.

In some embodiments of the present disclosure, in some other embodiments, based on the embodiments above, the establishment module includes: a spiking sequence acquisition module, a data set establishment module, and at least one of a simulation processing module and a spiking sequence acquisition module, wherein
a data acquisition module is configured to acquire emotion recognition-based raw visual data;
the simulation processing module is configured to perform simulation processing on the raw visual data by using a dynamic visual sensor simulation method, to obtain a plurality of spiking sequences corresponding to the raw visual data;
a first spiking sequence acquisition module is configured to directly acquire a plurality of spiking sequences corresponding to the raw visual data by using a dynamic visual camera; and
the data set establishment module is configured to establish an emotion recognition-based dynamic visual data set on the basis of the plurality of spiking sequences obtained by the simulation processing module or the spiking sequence acquisition module.

In some embodiments of the present disclosure, in some other embodiments, based on the embodiments above, the simulation processing module includes: a traversing module, a first conversion module and a first assignment module, wherein
the traversing module is configured to sequentially traverse N frames of video frame images in raw dynamic video data, where N represents the total number of video frame images contained in the raw visual data;
the first conversion module is configured to convert, when the traversing module traverses to a current ith frame, a video frame image of the current ith frame from an RGB color space to a grayscale space, and take the converted video frame data as current video frame data, where the numerical range of i is from 1 to N; and
the first assignment module is configured to assign, when the value of i is equal to 1, all floating-point data of the current video frame data to a first output channel of a first time step of simulation data, to obtain a spiking sequence composed of the first output channel.

In some embodiments of the present disclosure, in some other embodiments, based on the embodiments above, the simulation processing module further includes: a second assignment module, an update module and a second conversion module, wherein
the second assignment module is configured to respectively assign, when i is not equal to 1, the first output channel and a second output channel according to a grayscale difference value between the current video frame and the previous video frame and a preset threshold, and take the current video frame data as the previous video frame;
the first update module is configured to update the value of i by adding 1; and
the second conversion module is further configured to execute, when i updated by the update module is less than N, the step that the video frame image of the current ith frame is converted from the RGB color space to the grayscale space, and the converted video frame data is taken as current video frame data.

In some embodiments of the present disclosure, in some other embodiments, based on the embodiments above, the simulation processing module further includes: a second spiking sequence acquisition module, wherein
the second spiking sequence acquisition module is configured to complete traversing of the N frames of video frame images in the raw dynamic video data when i updated by the update module is not less than N, to obtain spiking sequences composed of the first output channel and the second output channel.

In some embodiments of the present disclosure, in some other embodiments, based on the embodiments above, the assignment module includes: a first calculation module, and at least one of a first position assignment module and a first position assignment module,
the first calculation module is configured to calculate, for each pixel, a grayscale difference value between the current video frame and the previous video frame at the pixel;
the first position assignment module is configured to assign 1 to a position corresponding to the first output channel when the grayscale difference value is greater than the preset threshold; and
the second position assignment module is configured to assign 1 to a position corresponding to the second output channel when the grayscale difference value is less than the preset threshold.

In some embodiments of the present disclosure, in some other embodiments, based on the embodiments above, the spiking neural network includes a voting neuronal population;
the second training module includes: an initialization module, a first propagation module, an error calculation module, a gradient calculation module, a second update module, a judgment module and a model training determination module, wherein
the initialization module is configured to initialize a parameter weight of the pre-established spiking neural network emotion recognition model;
the first propagation module is configured to use the dynamic visual data set as an input to the current spiking neural network in the spiking neural network emotion recognition model, and obtain an output frequency of the voting neuronal population of each emotion category via forward propagation of the current spiking neural network;
the error calculation module is configured to calculate, regarding each emotion category, an error between the output frequency of the voting neuronal population of the emotion category and a real label of a corresponding emotion category;
the gradient calculation module is configured to calculate a gradient corresponding to the parameter weight according to the error;
the second update module is configured to update the parameter weight of the current spiking neural network by using the gradient calculated by the gradient calculation module;
the judgment module is configured to judge whether the current spiking neural network after the parameter weight is updated by the update module converges; and
the model training determination module is configured to stop training when the judgment module judges that the current spiking neural network after updating the parameter weight has converged, to obtain a trained spiking neural network emotion recognition model.

In some embodiments of the present disclosure, in some other embodiments, based on the embodiments above, the second training module further includes: a second propagation module, wherein
the second propagation module is configured to use, when the judgment module judges that the current spiking neural network after updating the parameter weight has not converged, the dynamic visual data set as an input to the current spiking neural network in the spiking neural network emotion recognition model, and obtain an output frequency of the voting neuronal population of each emotion category via forward propagation of the current spiking neural network.

In some embodiments of the present disclosure, in some other embodiments, based on the embodiments above, the judgment module at least includes one of the following:
a first judgment module, configured to judge whether the current spiking neural network converges by judging whether current training number of times of the current spiking neural network after updating the parameter weight reaches a preset number of times;
a second judgment module, configured to judge whether the current spiking neural network converges by judging whether an error reduction degree of the current spiking neural network after updating the parameter weight is stabilized within a preset range;
a third judgment module, configured to judge whether the current spiking neural network converges by judging whether an error of the current spiking neural network after updating the parameter weight is less than an error threshold; and
a fourth judgment module, configured to judge whether the current spiking neural network after updating the parameter weight converges by a verification set in the dynamic visual data set.

In some embodiments of the present disclosure, in some other embodiments, based on the embodiments above, the spiking neural network further includes: a feature extraction module and an emotion mapping module, wherein the feature extraction module includes a single forward extraction unit composed of convolution, normalization, Parametric Leaky-Integrate and Fire (PLIF) model and average pooling, and a network unit composed of two fully-connected layers and two PLIF, which are arranged at intervals; and the emotion mapping module is configured to map spiking sequences outputted by the voting neuronal population module to a final emotion category.

Please further refer to FIG. 9, FIG. 9 is a structural block diagram of an apparatus for training emotion recognition model provided according to embodiments of the present disclosure, including: an establishment component 91 and a training component 92, wherein
the establishment component 91 is configured to pre-establish an emotion recognition-based dynamic visual data set; and
the training component 92 is configured to train a pre-established spiking neural network emotion recognition model by using the dynamic visual data set, to obtain a trained spiking neural network emotion recognition model.

Please further refer to FIG. 10, FIG. 10 is another block diagram of an apparatus for training emotion recognition model provided according to embodiments of the present disclosure, including: an acquisition component 11 and a training component 12, wherein
the acquisition component 11 is configured to acquire test sets of a plurality of emotion categories; and
the training component 12 is configured to perform test training on a pre-established spiking neural network emotion recognition model by using the test sets, to obtain a trained spiking neural network emotion recognition model.

With regard to the apparatuses in the embodiments above, the specific manner in which various components execute operations has been described in detail in the corresponding method embodiments, and will not be described in detail herein.

It should be noted that the apparatus for recognizing emotion provided in the embodiments of the present disclosure has the same beneficial effects as the method for recognizing emotion provided in the embodiments above; and for specific introduction of the method for recognizing emotion involved in the embodiments of the present disclosure, reference may be made to the embodiments above, and they will not be repeated herein.

On the basis of the embodiments above, embodiments of the present disclosure further provide an apparatus for recognizing emotion, including:
a memory, for storing a computer program; and
a processor, for implementing the method for recognizing emotion or the method for training emotion recognition model when executing the computer program.

For example, the processor in the embodiments of the present disclosure may be used for: acquiring to-be-recognized spiking sequences corresponding to video information; and recognizing the to-be-recognized spiking sequences by using a pre-established spiking neural network emotion recognition model, so as to obtain a corresponding emotion category; wherein the spiking neural network emotion recognition model is obtained by training a spiking neural network by using a pre-established dynamic visual data set.

Embodiments of the present disclosure further provide an electronic device, including:
a memory, for storing a computer program; and
a processor, for implementing the method for recognizing emotion or the method for training emotion recognition model when executing the computer program.

On the basis of the embodiments above, embodiments of the present disclosure further provide a computer non-transitory readable storage medium; the computer non-transitory readable storage medium stores a computer program, and when the computer program is executed by a processor, the method for recognizing emotion or the method for training emotion recognition model is implemented.

The computer non-transitory readable storage medium may include: various media that may store program codes, such as a USB flash disk, a removable hard disk, a Read-Only Memory (ROM), a Random Access Memory (RAM), a magnetic disk, or an optical disc.

In some embodiments of the present disclosure, embodiments of the present disclosure also provide a computer program product, including a computer program or instructions, which when executed by a processor, implement the method for recognizing emotion or the method for training emotion recognition model.

The apparatus embodiments as described above are merely exemplary. The unit blocks described as separate components may or may not be physically separated, and the components displayed as units may or may not be physical components, that is, may be located in one place, or may be distributed in a plurality of networks. Some or all of the components may be selected according to actual needs to achieve the purpose of the solutions of the embodiments. A person of ordinary skill in the art would understand and implement the embodiments without any inventive effort.

FIG. 11 is a block diagram of an electronic device 1100 provided according to embodiments of the present disclosure. For example, the electronic device 1100 may be a mobile terminal or a server. In the embodiments of the present disclosure, illustration is made by taking the electronic device being a mobile terminal as an example. For example, the electronic device 1100 may be a mobile phone, a computer, a digital broadcast terminal, a message transceiving device, a game console, a tablet device, a medical device, a fitness device, a personal digital assistant, or the like.

Refer to FIG. 11, the electronic device 1100 may include one or more of the following assemblies: a processing assembly 1102, a memory 1104, a power supply assembly 1106, a multimedia assembly 1108, an audio assembly 1110, an input/output (I/O) interface 1112, a sensor assembly 1114, and a communication assembly 1116.

The processing assembly 1102 generally controls overall operations of the electronic device 1100, such as operations associated with display, phone calls, data communications, camera operations and recording operations. The processing assembly 1102 may include one or more processors 1120 to execute instructions to complete all or some of the steps of the described methods. In addition, the processing assembly 1102 may include one or more components to facilitate interaction between the processing assembly 1102 and other assemblies. For example, the processing assembly 1102 may include a multimedia component to facilitate interaction between the multimedia assembly 1108 and the processing assembly 1102.

The memory 1104 is configured to store various types of data to support operations on the device 1100. Examples of such data include instructions for any application program or method operating on the electronic device 1100, contact data, telephone directory data, messages, pictures, video, etc. The memory 1104 may be implemented by any type of transitory or non-transitory storage device or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power supply assembly 1106 provides power for various assemblies of the electronic device 1100. The power supply assembly 1106 may include a power management system, one or more power supplies, and other assemblies associated with generation, management and distribution of power for the electronic device 1100.

The multimedia assembly 1108 includes a screen that provides an output interface between the electronic device 1100 and a user. In some embodiments, the screen may include a liquid crystal display (LCD) and a touch panel (TP). When the screen includes a touch panel, the screen may be implemented as a touch screen to receive an input signal from the user. The touch panel includes one or more touch sensors to sense a touch, a swipe, and a gesture on the touch panel. The touch sensor may not only sense boundaries of the touch or swipe actions, but also detect the duration and pressure associated with the touch or swipe operation. In some embodiments, the multimedia assembly 1108 includes a front-facing camera and/or a rear-facing camera. When the device 1100 is in an operation mode, such as a photographing mode or a video mode, the front-facing camera and/or the rear-facing camera may receive external multimedia data. Each front-facing camera and rear-facing camera may be a fixed optical lens system or have focal length and optical zooming capability.

The audio assembly 1110 is configured to output and/or input audio signals. For example, the audio assembly 1110 includes a microphone (MIC), and when the electronic device 1100 is in an operation mode, such as a call mode, a recording mode and a voice recognition mode, the microphone is configured to receive external audio signals. The received audio signals may be further stored in the memory 1104 or sent via the communication assembly 1116. In some embodiments, the audio assembly 1110 further includes a loudspeaker for outputting audio signals.

The I/O interface 1112 provides an interface between the processing assembly 1102 and a peripheral interface component, and the peripheral interface component may be a keyboard, a click wheel, buttons, etc. These buttons may include but are not limited to: a home button, a volume button, a start button and a lock button.

The sensor assembly 1114 includes one or more sensors, for providing state assessment of various aspects of the electronic device 1100. For example, the sensor assembly 1114 may detect an on/off state of the device 1100 and relative positioning of the assemblies, for example, the assemblies are display and keypad of the electronic device 1100; and the sensor assembly 1114 may also detect position change of the electronic device 1100 or position change of one assembly of the electronic device 1100, existence or non-existence of contact between the user and the electronic device 1100, orientation or acceleration/deceleration of the electronic device 1100, and temperature change of the electronic device 1100. The sensor assembly 1114 may include a proximity sensor configured to detect the presence of a nearby object in the absence of any physical contact. The sensor assembly 1114 may also include an optical sensor, such as a CMOS or CCD image sensor, for use in imaging applications. In some embodiments, the sensor assembly 1114 may also include an acceleration sensor, a gyro sensor, a magnetic sensor, a pressure sensor or a temperature sensor.

The communication assembly 1116 is configured to facilitate wired or wireless communications between the electronic device 1100 and other devices. The electronic device 1100 may access a wireless network based on a communication standard, such as Wi-Fi, operator networks (such as 2G, 3G, 4G or 5G), or a combination thereof. In some exemplary embodiments, the communication assembly 1116 receives broadcast signals or broadcast related information from an external broadcast management system via a broadcast channel. In some exemplary embodiments, the communication assembly 1116 also includes a near field communication (NFC) component to facilitate short-range communication. For example, the NFC component may be achieved on the basis of radio frequency identification (RFID) technology, infrared data association (IrDA) technology, ultra wideband (UWB) technology, Bluetooth (BT) technology and other technologies.

In embodiments, the electronic device 1100 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements, to perform the data decryption method or data encryption method as described above.

In embodiments, a computer-readable storage medium is also provided, and includes e.g., a memory 1104 including instructions, which may be executed by the processor 1120 of the electronic device 1100 to implement the data decryption method or data encryption method as described above. For example, a non-transitory computer-readable storage medium may be an ROM, a random access memory (RAM), a CD-ROM, a magnetic tape, a floppy disk, an optical data storage device, and the like.

In embodiments, a computer program product is further provided. When instructions in the computer program product are executed by the processor 1120 of the electronic device 1100, the electronic device 1100 is enabled to execute the data decryption method or the data encryption method as shown above.

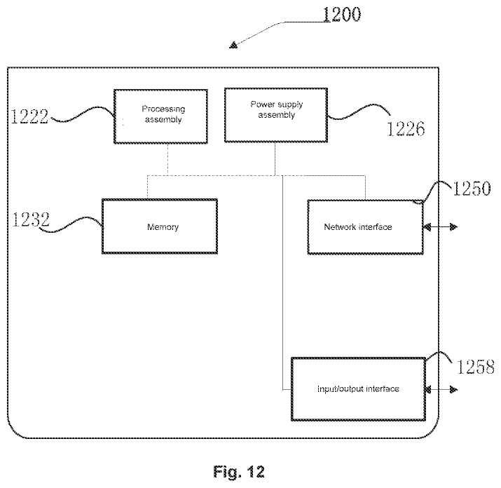

FIG. 12 is a block diagram of an apparatus 1200 for emotion recognition or emotion recognition model training provided according to embodiments of the present disclosure. For example, the apparatus 1200 may be provided as a server. Refer to FIG. 12, the apparatus 1200 includes a processing assembly 1222, which further includes: one or more processors; and memory resources, represented by a memory 1232 and for storing instructions, such as an application program, executable by the processing assembly 1222. The application program stored in the memory 1232 may include one or more components each corresponding to one group of instructions. In addition, the processing assembly 1222 is configured to execute the instructions, to implement the described methods.

The apparatus 1200 may also include a power supply assembly 1226 configured to perform power supply management of the apparatus 1200, a wired or wireless network interface 1250 configured to connect the apparatus 1200 to a network, and an input/output (I/O) interface 1258. The apparatus 1200 may operate on the basis of an operating system stored in the memory 1232, such as Windows Server™, Mac OS X™, Unix™, Linux™, FreeBSD™, or the like.

Various embodiments in the description are described in a progressive manner. Each embodiment focuses on differences from other embodiments. For the same or similar parts among the embodiments, reference may be made to each other. For the apparatuses disclosed in the embodiments, as the apparatuses correspond to the methods disclosed in the embodiments, the illustration thereof is relatively simple, and for the related parts, reference may be made to the illustration of the method part.

It should be noted that in the present description, relational terms such as first and second, etc. are only used to distinguish one entity or operation from another entity or operation, and do not necessarily require or imply any actual relationship or sequence between these entities or operations. Furthermore, terms “include” “including”, or any other variations thereof are intended to cover a non-exclusive inclusion, so that a process, a method, an article, or a device that includes a series of elements not only includes those elements, but also includes other elements that are not explicitly listed, or further includes inherent elements of the process, the method, the article, or the device. Without further limitation, an element defined by a sentence “including a . . . ” does not exclude other same elements existing in the process, the method, the article, or the device that includes the element.

The illustration of the disclosed embodiments enables a person skilled in the art to implement or use some embodiments of the present disclosure. Various modifications to these embodiments will be apparent to a person skilled in the art. The general principles defined herein may be implemented in other embodiments without departing from the spirit or scope of the present disclosure. Accordingly, the present disclosure will not be limited to these embodiments shown herein, but needs to comply with the widest scope consistent with the principles and novel features disclosed herein.

1. A method for recognizing emotion, comprising:
acquiring to-be-recognized spiking sequences corresponding to video information; and
recognizing the to-be-recognized spiking sequences by using a spiking neural network emotion recognition model, so as to obtain a corresponding emotion category.

2. The method for recognizing emotion as claimed in claim 1, wherein before recognizing the to-be-recognized spiking sequences by using the spiking neural network emotion recognition model, the method further comprises:
training a pre-established spiking neural network emotion recognition model, to obtain a trained spiking neural network emotion recognition model.

3. The method for recognizing emotion as claimed in claim 2, wherein training the pre-established spiking neural network emotion recognition model, to obtain the trained spiking neural network emotion recognition model, comprises:
acquiring test sets of a plurality of emotion categories; and
performing test training on the pre-established spiking neural network emotion recognition model by using the test sets, to obtain a trained spiking neural network emotion recognition model.

4. The method for recognizing emotion as claimed in claim 2, wherein training the pre-established spiking neural network emotion recognition model, to obtain the trained spiking neural network emotion recognition model, comprises:
pre-establishing an emotion recognition-based dynamic visual data set; and
training the pre-established spiking neural network emotion recognition model by using the dynamic visual data set, to obtain a trained spiking neural network emotion recognition model.

5. The method for recognizing emotion as claimed in claim 4, wherein the process of pre-establishing the emotion recognition-based dynamic visual data set comprises: acquiring emotion recognition-based raw visual data;
performing simulation processing on the raw visual data by using a dynamic visual sensor simulation method, to obtain a plurality of spiking sequences corresponding to the raw visual data; or directly acquiring a plurality of spiking sequences corresponding to the raw visual data by using a dynamic visual camera; and
establishing an emotion recognition-based dynamic visual data set on the basis of the plurality of spiking sequences.

6. The method for recognizing emotion as claimed in claim 5, wherein the process of performing simulation processing on the raw visual data by using the dynamic visual sensor simulation method, to obtain the plurality of spiking sequences corresponding to the raw visual data, comprises:
sequentially traversing N frames of video frame images in the raw dynamic video data, wherein N represents a total number of video frame images contained in the raw visual data;
when traversing to a current ith frame, converting a video frame image of the current ith frame from an RGB color space to a grayscale space, and taking the converted video frame data as current video frame data, wherein the numerical range of i is from 1 to N; and
when the value of i is equal to 1, assigning all floating-point data of the current video frame data to a first output channel of a first time step of simulation data, to obtain a spiking sequence composed of the first output channel, and taking the current video frame data as a previous video frame.

7. The method for recognizing emotion as claimed in claim 6, wherein the process of performing simulation processing on the raw visual data by using the dynamic visual sensor simulation method, to obtain corresponding spiking sequences, further comprises:
when i is not equal to 1, respectively assigning the first output channel and a second output channel according to a preset threshold and a grayscale difference value between the current video frame and the previous video frame, and taking the current video frame data as the previous video frame;
updating the value of i by adding 1; and
when a updated i is less than N, executing the step of converting the video frame image of the current ith frame from the RGB color space to the grayscale space, and taking the converted video frame data as the current video frame data.

8. The method for recognizing emotion as claimed in claim 7, wherein the process of performing simulation processing on the raw visual data by using the dynamic visual sensor simulation method, to obtain corresponding spiking sequences, further comprises:
when the updated i is not less than N, completing traversing of the N frames of video frame images in the raw dynamic video data, to obtain spiking sequences composed of the first output channel and the second output channel.

9. The method for recognizing emotion as claimed in claim 7, wherein respectively assigning the first output channel and the second output channel according to the grayscale difference value between the current video frame and the previous video frame and the preset threshold, comprises:
calculating, for each pixel, a grayscale difference value between the current video frame and the previous video frame at the pixel;
assigning 1 to a position corresponding to the first output channel when the grayscale difference value is greater than the preset threshold; or
assigning 1 to a position corresponding to the second output channel when the grayscale difference value is less than the preset threshold.

10. The method for recognizing emotion as claimed in claim 4, wherein the spiking neural network comprises a voting neuronal population component;
the process of training the pre-established spiking neural network emotion recognition model by using the dynamic visual data set, to obtain the trained spiking neural network emotion recognition model, comprises:
initializing a parameter weight of the pre-established spiking neural network emotion recognition model;
using the dynamic visual data set as an input to a current spiking neural network in the spiking neural network emotion recognition model, and obtaining an output frequency of a voting neuronal population of each emotion category via forward propagation of the current spiking neural network;
calculating, regarding each emotion category, an error between the output frequency of the voting neuronal population of the emotion category and a real label of a corresponding emotion category;
calculating a gradient corresponding to the parameter weight according to the error, and updating the parameter weight of the current spiking neural network by using the gradient; judging whether the current spiking neural network after updating the parameter weight converges; and
when it is judged that the current spiking neural network after updating the parameter weight has converged, stopping training, to obtain a trained spiking neural network emotion recognition model.

11. The method for recognizing emotion as claimed in claim 10, wherein the process of training the pre-established spiking neural network emotion recognition model by using the dynamic visual data set, to obtain the trained spiking neural network emotion recognition model, further comprises:
when it is judged that the current spiking neural network after updating the parameter weight has not converged, returning to execute the step of using the dynamic visual data set as the input to the current spiking neural network in the spiking neural network emotion recognition model, and obtaining the output frequency of the voting neuronal population of each emotion category via forward propagation of the current spiking neural network.

12. The method for recognizing emotion as claimed in claim 10, wherein judging whether the current spiking neural network after updating the parameter weight converges according to the following manners:
judging whether the current spiking neural network converges by judging whether current training number of times of the current spiking neural network after updating the parameter weight reaches a preset number of times; or
judging whether the current spiking neural network converges by judging whether an error reduction degree of the current spiking neural network after updating the parameter weight is stabilized within a preset range; or
judging whether the current spiking neural network converges by judging whether an error of the current spiking neural network after updating the parameter weight is less than an error threshold; or
judging whether the current spiking neural network after updating the parameter weight converges by a verification set in the dynamic visual data set.

13. The method for recognizing emotion as claimed in claim 10, wherein the spiking neural network further comprises: a feature extraction component and an emotion mapping component, wherein the feature extraction component comprises a single forward extraction unit composed of convolution, normalization, Parametric Leaky-Integrate and Fire (PLIF) model and average pooling, and a network unit composed of two fully-connected layers and two PLIF, which are arranged at intervals; and the emotion mapping component is configured to map spiking sequences outputted by the voting neuronal population to a final emotion category.

14. (canceled)

15. (canceled)

16. (canceled)

17. (canceled)

18. (canceled)

19. An electronic device, comprising:
a memory, for storing a computer program; and
a processor, for executing the computer program to cause the processor to:
acquire to-be-recognized spiking sequences corresponding to video information; and recognize the to-be-recognized spiking sequences by using a spiking neural network emotion recognition model, so as to obtain a corresponding emotion category.

20. A computer non-transitory readable storage medium, wherein the computer non-transitory readable storage medium stores a computer program, which when executed by a processor, cause the processor to:
acquire to-be-recognized spiking sequences corresponding to video information; and recognize the to-be-recognized spiking sequences by using a spiking neural network emotion recognition model, so as to obtain a corresponding emotion category.

21. (canceled)

22. The method for recognizing emotion as claimed in claim 5, wherein the spiking sequences corresponding to one piece of the raw visual data are a spiking sequence array constituted by spiking sequences at each pixel positions of each video pictures in the whole raw visual data.

23. The method for recognizing emotion as claimed in claim 10, wherein the step of calculating the gradient corresponding to the parameter weight according to the error comprises:
obtaining a final average error according to errors corresponding to voting neuronal populations; calculating the gradient corresponding to the parameter weight according to the average error.

24. The method for recognizing emotion as claimed in claim 10, the methods for judging whether the current spiking neural network converges comprises:
judging whether the current training number of times reaches a preset number of times; when the current training number of times reaches a preset number of times, determining that the current spiking neural network has converged, and when the current training number of times does not reaches the preset number of times, determining that the current spiking neural network has not converged; or
judging whether an error reduction degree of the current spiking neural network is stabilized within a preset range; when the error reduction degree of the current spiking neural network is stabilized within the preset range, determining that the current spiking neural network has converged; and when the error reduction degree of the current spiking neural network is not stabilized within the preset range, determining that the current spiking neural network has not converged; or
judging whether the current spiking neural network converges by judging whether an error based on the current spiking neural network is less than an error threshold; when the error based on the current spiking neural network is less than the error threshold, determining that the current spiking neural network has converged, and when the error based on the current spiking neural network is not less than the error threshold, determining that the current spiking neural network has not converged.

25. The computer non-transitory readable storage medium as claimed in claim 20, wherein the computer program further causes the processor to:
train a pre-established spiking neural network emotion recognition model, to obtain a trained spiking neural network emotion recognition model.

26. The computer non-transitory readable storage medium as claimed in claim 25, wherein the computer program further causes the processor to:
acquire test sets of a plurality of emotion categories; and
perform test training on the pre-established spiking neural network emotion recognition model by using the test sets, to obtain a trained spiking neural network emotion recognition model.
